(19) United States
(12) Patent Application Publication
(10) Pub. No.: US 2004/0256990 A1
(43) Pub. Date: Dec. 23, 2004

(54) Plasma display panel

(76) Inventor: Morio Fujitani, Takatsuki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/501,137

(22) PCT Filed: Jan. 21, 2004
(86) PCT No.: PCT/JP04/00462

(30) Foreign Application Priority Data
Jan. 24, 2003 (JP) 2003-015871

(51) Int. Cl. H01J 17/49

(52) U.S. Cl. 313/586; 313/587; 313/582

(57) ABSTRACT

A plasma display panel free from blisters and pinholes on dielectric layers and excellent in characteristic of breakdown voltage. This plasma display panel has multilayered first dielectric layer (7) covering a display electrode including a scanning electrode and a sustain electrode provided on front substrate (3), and a multilayered second dielectric layer covering a data electrode provided on a back substrate, wherein periphery (21) of upper dielectric layer (7b) of first dielectric layer (7) and/or the second dielectric layer is positioned identically or partially in size and shape to periphery (22) of lower dielectric layer (7a) to be formed.

### TECHNICAL FIELD

The present invention relates to a plasma display panel that is known as a display device.

### BACKGROUND ART

A plasma display panel displays images by exciting a phospher with ultraviolet light generated by gas discharge for light emission.

A plasma display device using such a plasma display panel has a higher display quality than a liquid crystal panel in features including high-speed display capability, a wide viewing angle, easy upsizing, and self-luminous property. Thus the plasma panel especially attracts attention among flat-panel displays these days, being used in various applications such as a display device for a location where many people gather or for enjoying a large-screen image at home.

A plasma display panel is roughly classified into an AC type and DC type by driving method, and a surface-discharge type and opposed-discharge type by discharging type. In terms of moving to finer-resolution, increasing size of a screen, and simplicity of the structure, a plasma display panel with a three-electrode structure prevails that is a surface-discharge type and AC type. An AC-type plasma display panel is composed of a front panel and a back panel. The front panel, equipped with display electrodes composed of scanning electrodes and sustain electrodes on the front substrate (a glass substrate), forms a first dielectric layer covering the display electrodes. Meanwhile, the back panel, equipped with providing at least a plurality of data electrodes orthogonal to the display electrodes on the back substrate (a glass substrate), forms a second dielectric layer covering the data electrodes. Arranging the front panel and the back panel facing each other forms discharge cells at the intercepts of the display electrodes and data electrodes, and also provides phospher layers in the discharge cells.

In the structure of such a plasma display panel, an example for a multilayered structure of the first dielectric layer and/or second dielectric layer is disclosed in the FPD Technology Outlook 2001 (Electronic Journal, Co., Oct. 25, 2000, pp. 594-597) for example. Its objective includes, using a material with a high glass softening point for the lower layer, and a low one for the upper layer for example, covering defects such as pinholes generated while forming the lower layer, on the upper layer, thus improving the breakdown voltage. Also, these dielectric layers are formed not in a single coating but in several times laminating for a certain thickness, which will result in a favorable surface roughness.

However, in some cases, although these dielectric layers are formed in the above-mentioned way, convex blisters formed on the surface cause the surface roughness to be unfavorable, or pinholes generated decrease the breakdown voltage.

As a result of researches on these problems made by the present inventor, the following facts have been found. FIGS. 5, 6, and 7 are sectional views schematically illustrating conditions of the end part of the dielectric layer when a dielectric material with such a conventional laminated structure is formed, where the first dielectric layer formed on the front panel is shown as an example. The description is made for an example where, as shown in FIG. 5, on front substrate 23, first dielectric layer 27 is composed of two layers, i.e. lower dielectric layer 27a and upper dielectric layer 27b. If upper dielectric layer 27b is formed with the periphery of lower dielectric layer 27a covered, bubble 101 is involved between the periphery of lower dielectric layer 27a and upper dielectric layer 27b. In such a case, as shown in FIG. 6, this bubble 101 expands in a following baking process, causing blister 102 to occur on first dielectric layer 27. In addition, as shown in FIG. 8, burst blisters cause pinhole 103 to occur on upper dielectric layer 27b, resulting in the performance of breakdown voltage of first dielectric layer 27 to be deteriorated. This problem is also found in the second dielectric layer provided in the back panel.

The present invention has been made from these situations and its objective is to implement a plasma display panel enabling a favorable image display, having dielectric layers with a multilayered structure preventing bubbles from being contained.

### SUMMERY OF THE INVENTION

sustain A plasma display panel including the following elements:

a multilayered first dielectric layer for covering a display electrode, which is provided on a front substrate and formed of a scanning electrode and a sustain sustain electrode, and a multilayered second dielectric layer for covering a data electrode provided on a back substrate,

where a periphery of an upper dielectric layer of the first dielectric layer is positioned identically or partially in size and shape to a periphery of a lower dielectric layer thereof and/or a periphery of an upper dielectric layer of the second dielectric layer is positioned identically or partially in size and shape to a periphery of a lower dielectric layer thereof.

This structure enables implementing a plasma display panel with dielectric layers with an excellent characteristic of breakdown voltage, preventing bubbles from being generated on the periphery of the dielectric layers.

### BRIEF DESCRIPTION OF THE DRAWINGS

FIG. 1 is a sectional perspective view schematically showing the configuration of a plasma display panel as one embodiment of the present invention.

FIG. 2 is a sectional view showing another structure of the front panel of the plasma display panel.

FIG. 3 is a sectional view schematically showing the configuration at an end of the front panel of the plasma display panel.

FIG. 4 is a plan view showing the positional relation between a first dielectric layer and a sealing member of the plasma display panel.

FIG. 5 is a sectional view typically showing a condition of a dielectric layer end when a dielectric layer with a conventional laminated structure is formed.

FIG. 6 is a sectional view typically showing the condition of a dielectric layer end after baking when a dielectric layer with a conventional laminated structure is formed.

FIG. 7 is a sectional view typically showing the condition of another dielectric layer end after baking when a dielectric layer with a conventional laminated structure is formed.

### DETAILED DESCRIPTION OF PREFERRED EMBODIMENT

The following section describes a plasma display panel as one embodiment of the present invention using drawings.

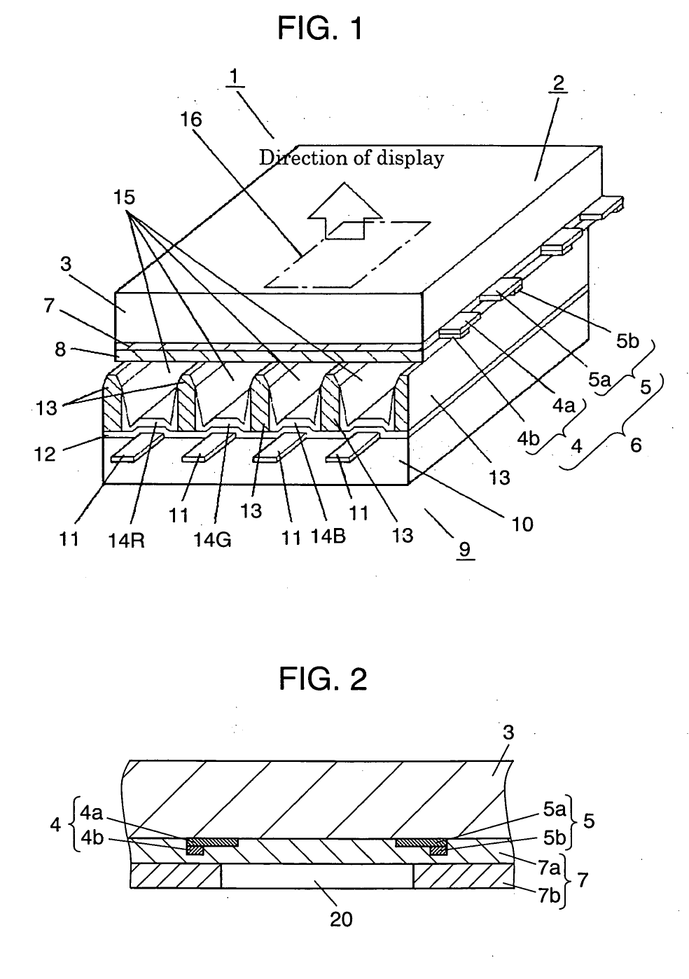

FIG. 1 is a sectional perspective view schematically showing the configuration of a plasma display panel as one embodiment of the present invention.

As illustrated in FIG. 1, PDP 1 is composed of front panel 2 and back panel 9. Front panel 2 is equipped with, on substrate 3 such as a transparent and insulating glass substrate, display electrode 6 composed of scanning electrode 4 and sustain electrode 5, first dielectric layer 7 covering display electrode 6, and also protective layer 8 made of an MgO film covering first dielectric layer 7. In this case, scanning electrode 4 and sustain electrode 5, aiming at securing transparency and reducing electrical resistance, have a structure wherein bus electrodes 4b and 5b made of a metallic material are laminated on transparent electrodes 4a and 5a for example. Further, first dielectric layer 7 is formed in a way as follows: Front substrate 3 is coated with a dielectric material paste containing low-melting-point glass powder using screen printing or die coating, or alternatively a precursor material layer made of a sheet-like dielectric material formed on a transfer film is transferred and sealed on the respective substrates, and then baked.

Back panel 9 is formed of data electrode 11 and second dielectric layer 12 for covering data electrode 11, both of which are disposed on back substrate 10 such as an insulating glass substrate for example. Further, barrier rib 13 parallel to data electrode 11 is formed on second dielectric layer 12, and phospher layers 14R, 14G, and 14B are provided on the surface of second dielectric layer 12 and on the side of barrier rib 13. Here, second dielectric layer 12 is formed in the same way as for first dielectric layer 7 as follows: Back substrate 10 is coated with a dielectric material paste containing low-melting-point glass powder using screen printing or die coating, or alternatively a precursor material layer made of a sheet-like dielectric material formed on a transfer film is transferred and sealed on the respective substrates, and then baked.

Front panel 2 and back panel 9 are arranged facing each other with discharge space 15 intervening so that display electrode 6 and data electrode 11 are orthogonalized, and are sealed with a sealing member formed on the periphery. At least one kind of noble gas out of helium, neon, argon, or xenon is filled as discharge gas in discharge space 15. Discharge space 15 is partitioned by barrier rib 13, and discharge space 15 at the intercept of display electrode 6 and data electrode 11 works as discharge cell 16.

The characteristic points of the plasma display panel in the above-mentioned embodiment of the present invention are as follows: First dielectric layer 7 and/or second dielectric layer 12 are in a multilayered structure, and also each upper layer is arranged so as not to cover the periphery of the lower layer. The first objective of making first dielectric layer 7 and/or second dielectric layer 12 a multilayered structure is, for example, by using a material with a high glass softening point for the lower layer, and a low one for the upper layer, to cover defects such as pinholes generated on the lower layer, by the upper layer, thus improving the breakdown voltage. Another objective is, by laminating and coating first dielectric layer 7 and/or second dielectric layer 12 in several times for a certain thickness, to make the surface roughness favorable. Further, as shown in FIG. 2, which is a sectional view of front panel 1, in discharge cell 16, first dielectric layer 7 is in a two-layer laminated structure with lower dielectric layer 7a and upper dielectric layer 7b, and upper dielectric layer 7b includes hole 20, enabling first dielectric layer 7 having a recess corresponding to the discharge cell to be formed easily.

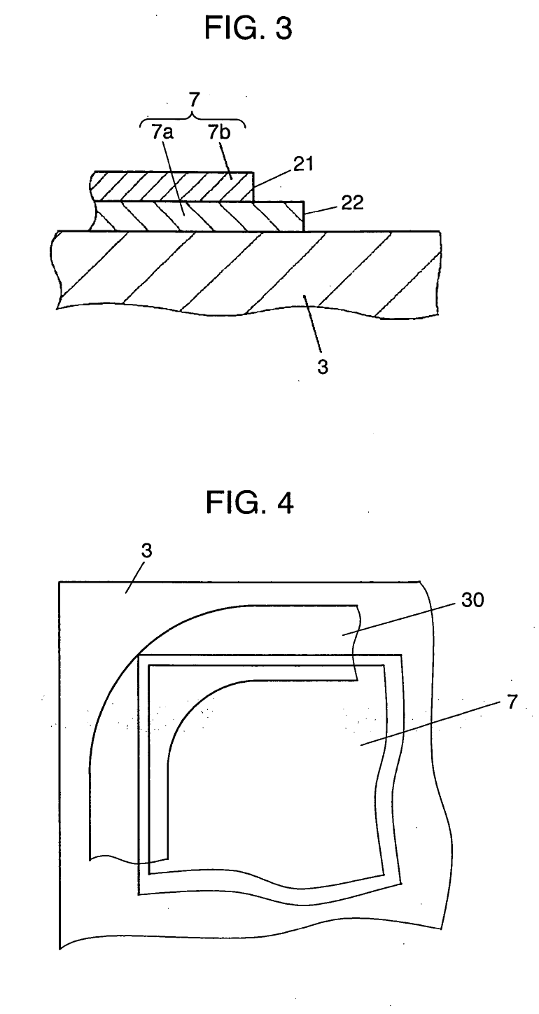

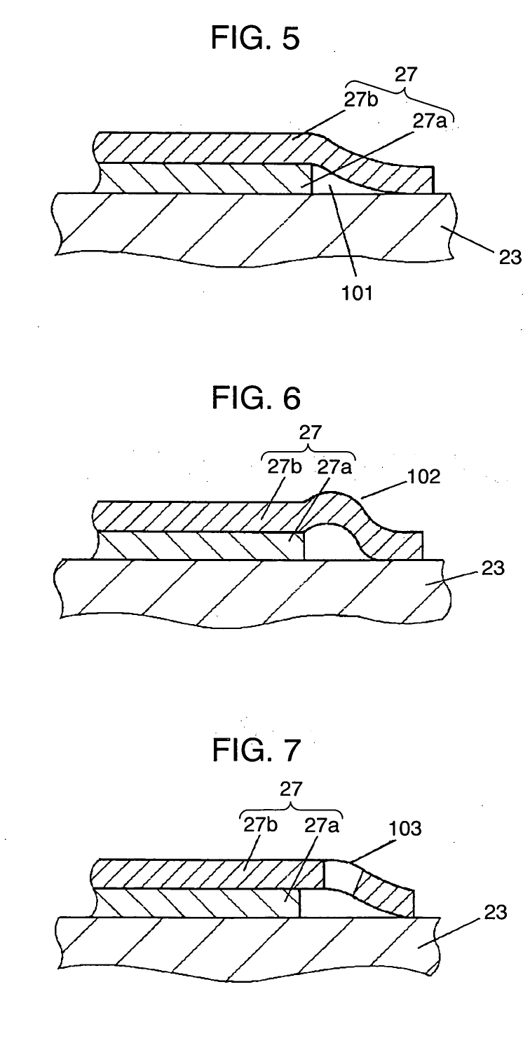

FIG. 3 schematically shows a sectional view for the configuration at the end of front panel 2 of PDP 1 in the embodiment of the present invention. FIG. 3 illustrates front substrate 3 and first dielectric layer 7 only for simplicity of the description, and a case of a two-layer structure. As shown in FIG. 3, in the present invention, periphery 21 of the upper dielectric layer 7b of the first dielectric layer is positioned identically or partially in size and shape to the periphery 22 of the lower dielectric layer 7a to be formed, preventing upper dielectric layer 7b from covering the periphery of lower dielectric layer 7a. This enables restricting bubbles that would be involved if upper dielectric layer 7b covered the periphery of lower dielectric layer 7a as shown in FIG. 5. As a result, blisters and pinholes supposedly caused by bubbles contained and the consequent defect in breakdown voltage can be prevented from occurring in first dielectric layer 7.

In addition, although a case of a two-layer structure is described in this embodiment, even for a multilayered structure with two or more layers, as long as the upper dielectric layer is structured so as not to cover the lower dielectric layer, the same advantage can be offered, as well as for second dielectric layer 12 of back panel 9.

Next, the method for forming first dielectric layer 7 mentioned above is described.

As a first example, the following method is given. First of all, after coating front substrate 3a with a dielectric material paste containing low-melting-point glass powder, a binding resin and a solvent, using a screen printing plate for lower dielectric layer 7a, dry the paste to form lower dielectric layer 7a. Next, after coating lower dielectric layer 7a with the paste using a screen printing plate for upper dielectric layer 7b, dry the paste, and then form a precursor of two-layer first dielectric layer 7. In this case, the screen printing plate for upper dielectric layer 7b is smaller than that for lower dielectric layer 7a, and periphery 21 of upper dielectric layer 7b is arranged identically or partially in size and shape to the periphery of lower dielectric layer 7a with appropriate positioning. With screen printing in this way, do not cover periphery 22 of lower dielectric layer 7a with upper dielectric layer 7b. Then bake the precursor to form two-layer first dielectric layer 7. In baking, leave the precursor for a few to several tens of minutes at a temperature higher than the softening point of the low-melting-point glass powder contained in the precursor of first dielectric layer 7 after dried. The baking changes the precursor of first dielectric layer 7 to first dielectric layer 7. Baking may be performed every time lower dielectric layer 7a and upper dielectric layer 7b are coated and dried respectively, or at one time after both of them are coated and dried.

As a second example, the following method is given. After coating front substrate 3 with a dielectric material paste containing low-melting-point glass powder, a binding resin, a photosensitive material and a solvent, using die coating, dry the paste to form a precursor of first dielectric layer 7, and then bake the precursor. Also in this case, when die-coating upper dielectric layer 7b, in order for upper dielectric layer 7b not to cover the periphery of lower dielectric layer 7a, the area to be coated by a die coater and the positioning need to be appropriate. The same method applies to baking.

As a third example, the following method is given. After coating a supporting film with a dielectric material paste containing low-melting-point glass powder, a binding resin, a photosensitive material and a solvent, dry the paste to make a transfer film formed as a dielectric film. Next transfer and laminate the dielectric film from the transfer film onto a substrate to form a precursor of multilayered first dielectric layer 7, and then bake the precursor. Also in this case, in order for the layer to be transferred as upper dielectric layer 7b not to cover the periphery of the layer transferred as lower dielectric layer 7a, the size of the dielectric film formed on the transfer film, and the accuracy in transfer position need to be adjusted appropriately. In this case, when transferring the dielectric film from the transfer film, because the dielectric film is like a sheet, if upper dielectric layer 7b is transferred so that it covers the periphery of lower dielectric layer 7a, a lot of bubbles will be involved. This means applying the present invention will notably achieve a great effect.

Here, the transfer film is formed as follows: After coating a supporting film with a photosensitive dielectric paste using a roller coater, blade coater, curtain coater, or the like, dry the paste and then remove a part or whole of the aforementioned solvent. Then pressing a cover film over it to bond completes the production. The transfer process wherein the dielectric film is transferred from the transfer film to the substrate is as follows: After detaching the cover film from the transfer film, lap the transfer film over the substrate surface so that the dielectric film contacts the substrate surface, thermocompress over the transfer film using a heating roller, and then detach the supporting film. Such an operation is performed by a laminating device. Further, after exposing the precursor of first dielectric layer 7 formed on the substrate, to the irradiation of ultraviolet light through a certain form of mask, the development enables controlling the size of the periphery of lower dielectric layer 7a and upper dielectric layer 7b. In baking, leave the precursor for a few to several tens of minutes at a temperature higher than the softening point of the low-melting-point glass powder contained in the precursor of first dielectric layer 7. This operation enables the precursor of first dielectric layer 7 to be changed to first dielectric layer 7 with desirable size and shape.

FIG. 4 is a plan view showing the positional relationship between the first dielectric layer and the sealing member of the plasma display panel. As shown in FIG. 4, if the periphery of first dielectric layer 7 is covered with sealing member 30, bubbles are involved in the periphery as conventionally, and blisters and burst parts are generated, the distance is affected between front glass substrate 3 and back glass substrate 10 arranged facing each other with sealing member 30 intervening. Consequently, a crosstalk and a noise (buzz) during display of images may occur. However, applying the present invention to the above-mentioned configuration wherein the periphery of first dielectric layer 7 is covered with sealing member 30, can prevent blisters and burst parts from occurring on the periphery of first dielectric layer 7, thus enabling the aforementioned problems to be controlled.

Although the above section describes a case wherein first dielectric layer 7 is in a two-layer structure, even for a multilayered structure with two or more layers, repeating the above-mentioned forming method enables forming layers in the same way.

In addition, the present invention is also applicable to second dielectric layer 12 covering data electrode 11 on back panel 9, allowing the similar effect to be achieved.

### INDUSTRIAL APPLICABILITY

The present invention enables implementing a plasma display panel with dielectric layers with an excellent characteristic of breakdown voltage by restricting bubbles generated on the peripherys of the dielectric layers, to be applied to a plasma display device, for example, that displays favorable images.

Reference Marks in the Drawings

1 Plasma display panel

2 Front panel

3 Front substrate

4 Scanning electrode

4a, 5a Transparent electrodes

4b, 5b Bus electrodes

5 Sutain electrode

6 Display electrode

7 First dielectric layer

7a Lower dielectric layer

7b Upper dielectric layer

8 Protective layer

9 Back panel

10 Back substrate

11 Data electrode

12 Second dielectric layer

13 Barrier rib

14R, 14G, 14B Phospher layers

15 Discharge space

16 Discharge cell

20 Hole

21 Periphery (of upper dielectric layer)

22 Periphery (of lower dielectric layer)

30 Sealing member

1. A plasma display panel comprising:
a multilayered first dielectric layer for covering a display electrode, which is provided on a front substrate and formed of a scanning electrode and a sustain electrode; and
a multilayered second dielectric layer for covering a data electrode provided on a back substrate,
wherein a periphery of an upper dielectric layer of the first dielectric layer is positioned identically or partially in size and shape to a periphery of a lower dielectric layer thereof and/or
a periphery of an upper dielectric layer of the second dielectric layer is positioned identically or partially in size and shape to a periphery of a lower dielectric layer thereof.
